(19) United States
(12) Patent Application Publication
(10) Pub. No.: US 2013/0120424 A1
(43) Pub. Date: May 16, 2013

(54) METHOD AND APPARATUS FOR IMPROVED RENDERING OF IMAGES

(71) Applicants: Robert Nance, Solana Beach, CA (US); Shyama Prasad Mondal, San Diego, CA (US)

(72) Inventors: Robert Nance, Solana Beach, CA (US); Shyama Prasad Mondal, San Diego, CA (US)

(73) Assignee: QUALCOMM INNOVATION CENTER, INC., San Diego, CA (US)

(21) Appl. No.: 13/295,259

(22) Filed: Nov. 14, 2011

(51) Int. Cl. G09G 5/00

(52) U.S. Cl. 345/582; 345/634

(57) ABSTRACT

Methods and devices for displaying content with improved speed, performance, and/or improved power efficiency are disclosed. In accordance with many embodiments, content is received that includes a plurality of objects including an image object, and the image object is decoded to obtain a bitmap representation of an image. A pattern of usage of the bitmap representation is identified that indicates whether the bitmap representation may be used repetitively when the plurality of objects are composited, and the bitmap representation is analyzed to identify whether compositing computations may be avoided a next time the bitmap representation is composited. The bitmap representation is then composited in a manner to avoid at least some of the compositing computations.

### FIELD OF THE INVENTION

The present invention relates to content display devices. In particular, but not by way of limitation, the present invention relates to apparatus and methods for improving the performance of content rendering on content display devices.

### BACKGROUND OF THE INVENTION

Content display devices such as smartphones, netbooks, gaming devices, PDAs, desktop computers, televisions, and laptop computers are now ubiquitous. And these devices now very commonly include hardware that provides network connectively to web servers and software (e.g., web browsers) that provide an interface for users to request and view content from these web servers.

The content that is provided by these web servers, and displayed on these content display devices, is increasingly dynamic in nature. In addition to graphically intensive games, for example, it is very common for a variety of content associated with a webpage to include animations, which may be carried out by rendering a series of bitmap images to create the appearance of motion. Common and ongoing issues with the display of this type of content are maintaining the quality of a user's experience while managing limited power resources.

More specifically, users have become accustomed to viewing animated content in a smooth, fast, and uninterrupted manner. Although content display devices continue to be produced with more and more advanced graphics processing resources, these resources are still not fast enough to provide seamless, consistent animation and/or these advanced content display devices demand more and more power, which is often limited. As a consequence, current devices are often less than desirable and will almost certainly be unacceptable in the future.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

Consistent with several embodiments, the invention may be characterized as a method and content display device for displaying content. In operation, webpage content is received that includes a plurality of objects, and an image object is decoded from the webpage content to obtain a bitmap representation of the image. A pattern of usage of the bitmap representation is then identified that indicates the bitmap representation may be used repetitively when the plurality of objects are composited. The bitmap representation is then analyzed to identify whether compositing computations may be avoided a next time the bitmap representation is composited, and the bitmap representation is then composited, while avoiding at least some of the compositing computations, to display the bitmap representation.

Although not required, in some embodiments the bitmap representation of the image is loaded as a texture into a graphics processing unit of the communication device and the texture is held in the graphics processing unit for repeated use when compositing.

The bitmap representation may be analyzed to identify contiguous portions of the bitmap representation that have pixels with an alpha value of 0 or 255, and the compositing of the contiguous portions of the bitmap representation that have pixels with an alpha value of 0 may be skipped, and the contiguous portions of the bitmap representation that have pixels with an alpha value of 255 may be copied.

In addition, the bitmap representation may be analyzed to determine whether the bitmap representation is repetitively rotated, and during compositing the cached representations of rotational-states of the bitmap image are composited to avoid at least some of the compositing computations.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings where like or similar elements are designated with identical reference numerals throughout the several views and wherein:

FIG. 1 is a block diagram depicting an exemplary embodiment of a content display device;

FIG. 2 is a block diagram depicting another content display device that includes a bitmap image that includes a plurality of image segments that may be sequentially rendered;

FIG. 3 is a block diagram depicting a variation of the content display device depicted in FIGS. 1 and 2;

FIG. 4 is a flow chart depicting general steps that may be carried out in connection with any of the content display devices described with reference to FIGS. 1-3;

FIG. 5 block diagram depicting physical components that may be used to realize the functional components depicted in FIGS. 1-3; and

FIG. 6 is a depiction of an exemplary bitmap image that includes regions of transparent pixels, opaque pixels, and semi-transparent pixels.

### DETAILED DESCRIPTION

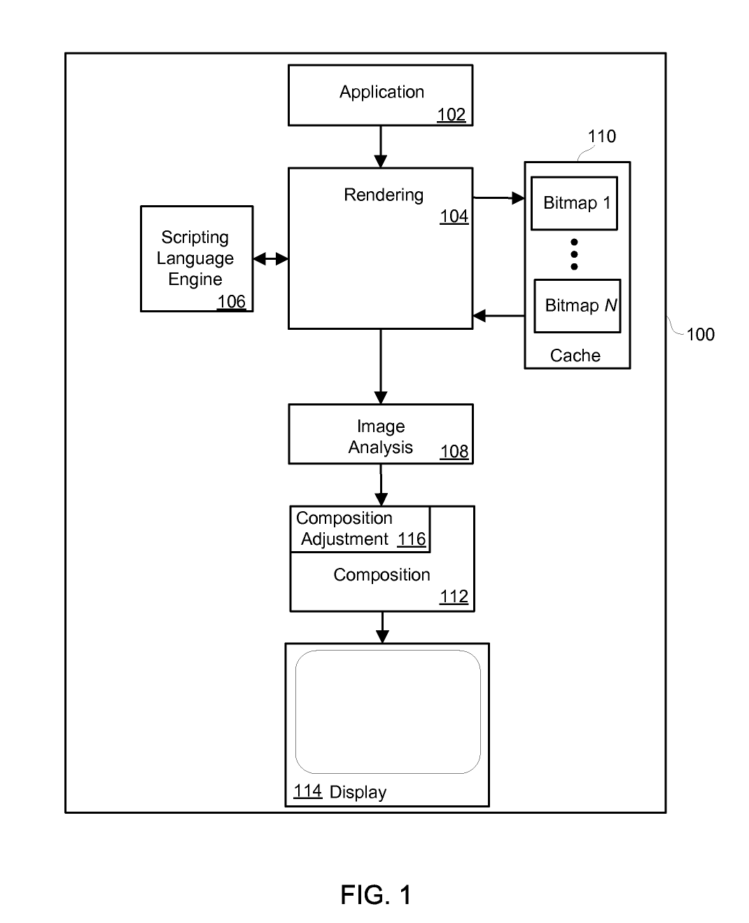

Referring first to FIG. 1, it is a block diagram depicting an embodiment of an exemplary content display device 100. As discussed further herein, the exemplary content display device 100 provides an improved user experience and/or reduced power consumption by reducing compositing computations that are carried out during the display of animated content. In many embodiments for example, images that are composited repeatedly are analyzed to determine whether at least some compositing computations may be avoided; thus improving performance of the rendering of the animations.

As shown, the content display device 100 includes an application 102 in communication with a rendering component 104 that is in communication with a scripting language engine 106, an image analysis component 108, and a cache 110 that includes N bitmap images. As depicted, a composition component 112 is in communication with the image analysis component 108 and provides an output that is displayed by a display 114, and the composition component 112 includes a composition adjustment component 116.

The depiction of these components is logical and is not intended to be an actual hardware diagram. For example, the division of browser-engine-related components (e.g., the rendering component 104, scripting language engine 106, image analysis component 108, composition component 112, and composition adjustment component 116) is for exemplary purposes only, and each component may be further separated into constituent components, but it should also be recognized that the components may be integrated to such an extent that each component may not be separately recognizable in actual implementation. Moreover, the components may be realized by hardware, software, firmware, or a combination thereof. And although not required, the image analysis component 108 and the composition adjustment component 116 may be realized by additions and modifications readily apparent to one of ordinary skill in the art—in light of this disclosure—to an existing browser engine. For example, a Webkit engine may be modified to include the image analysis functionality and composition adjustment functionality discussed herein.

The content display device 100 may be realized by a variety of devices such as smartphones, netbooks, gaming devices, PDAs, desktop computers, televisions, tablets, and laptop computers, and the application 102 may be any of a variety of applications that a user interacts with to request, retrieve and view animated content such as a web browser, or any of a variety of other applications that utilize animated content (e.g., gaming, utility, and educational apps).

The rendering component 104 generally functions to receive web page objects from the application 102 and transform the received objects of the content into a raster. For example, the rendering component 104 transforms bitmap graphics, vector graphics and text that make up a web page into a raster that can be displayed on screen. A typical web page may have more than 150 objects to render, which may include one or more backgrounds, scripting-language objects (e.g., JavaScript), HTML objects, CSS objects, JPEGs, PNGs, and video objects.

In the context of animation content, for example, in many instances the content is provided in connection with scripting language code (e.g., JavaScript) that controls how the constituent elements of the animation are rendered. In these instances, the rendering engine 104 receives and decodes image objects (e.g., JPEG, PNG, GIF, TIFF objects) to generate the N bitmap representations of the received image objects that are placed in the cache 110. And then, at the direction of the scripting language code when executed by the scripting language engine 106, the N bitmap images are retrieved from memory and composited by the composition component 112 in a manner (e.g., sequential display) that provides the appearance of animation to the user.

The image analysis component 108 in this embodiment generally operates to identify a pattern of usage of each of the N bitmap images that indicates whether each of the plurality of bitmap images may be used repetitively, and to identify whether at least some compositing computations may be avoided a next time the repeated bitmap images are composited. In some implementations for example, a number of times that a particular one of the N bitmap images is utilized is tracked, and if the number of times the particular bitmap image is used exceeds a threshold, then the likelihood that the particular bitmap image will be used again is high enough that an analysis of the particular bitmap image is warranted to determine whether at least some compositing computations may be avoided a next time the particular bitmap image is composited.

As one of ordinary skill the art will appreciate, the particular threshold that triggers an analysis of a bitmap image may vary depending upon a variety of factors (e.g., the time and/or processing that is saved when an analysis is done versus the time and/or processing that is required to effectuate the analysis), but in some instances, the threshold may be two uses so that once a particular bitmap image has been used twice, that particular bitmap image is analyzed to determine whether compositing computations may be avoided a next time the bitmap representation is composited. In other instances, the threshold may be three or four uses of a particular bitmap image before that particular bitmap image is analyzed for potential compositing computational savings.

As shown in FIG. 1, the composition component 112 includes a composition adjustment component 116, which operates, responsive to the image analysis component 108 indicating compositing computations may be avoided, to alter operation of the composition component 112 so as to reduce compositing computations that are effectuated by the composition component 112.

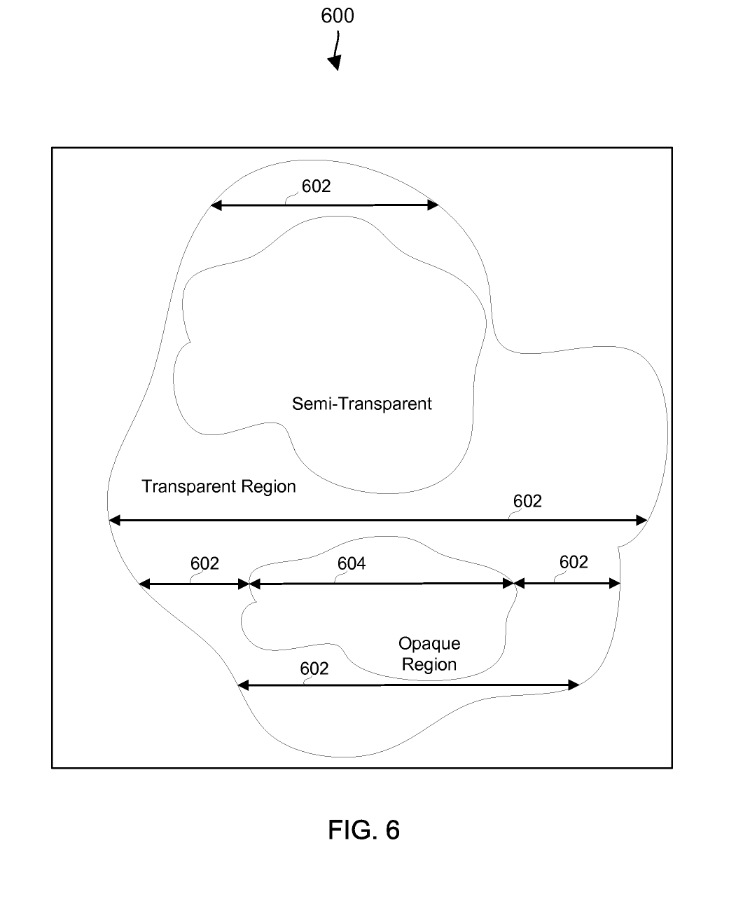

Referring to FIG. 6, for example, shown is an exemplary bit map image 600 that includes a transparent region, an opaque region, and a semi-transparent region. For purposes of example, it is assumed that the image analysis component 108 has determined that an analysis is warranted to determine whether compositing computations may be avoided to reduce compositing calculations.

As shown in FIG. 6, a transparent region includes large contiguous portions 602 of pixels that are transparent (e.g., the pixels in these contiguous regions have an alpha value of zero). As a consequence, these portions may be skipped over by the composition component 112. Thus the image analysis component 108 in the exemplary embodiment analyzes whether contiguous portions have pixels with an alpha value of zero, and the composition adjustment component 116 alters the operation of the composition component 112 so that the contiguous portions of pixels that have an alpha value of zero are skipped during compositing. As a result, a substantial amount of the computations that would ordinarily take place to composite the transparent region are avoided.

In addition, an opaque region in FIG. 6 includes contiguous portions 604 of pixels that are opaque (e.g., the pixels in the opaque portions 604 have an alpha value of 255). As a consequence, these portions 604 may be copied by the composition component 112. Thus the image analysis component 108 in the exemplary embodiment analyzes whether there are contiguous portions that have pixels with an alpha value of 255, and the composition adjustment component 116 is configured to alter the operation of the composition component 112 so the contiguous portions 604 of pixels that have an alpha value of 255 are copied during compositing. As a result, a substantial amount of the computations that would ordinarily take place to composite the opaque region are avoided.

Referring again to FIG. 1, another operation that may be performed by the image analysis component 108 is an analysis of whether any of the N bitmap images are likely to be rotated repetitively. For example, the image analysis component 108 may track both how the N bitmap images are used and how often the N bitmap images are used. And if a particular bitmap image is likely to be repetitively rotated, then a representation of each state of the bitmap image may be cached in the cache 110. For example, if a particular bitmap image is successively rotated six times in increments of 60 degrees in connection with an animation of the particular bitmap image rotating a total of 360 degrees, six representations of the particular bitmap image may be stored in the cache 110. And each of the six cached representations of the bitmap image may be analyzed to determine if there are contiguous portions of pixels that may simply be skipped (e.g., because they are transparent) or may be copied (e.g., because they are opaque).

As a consequence, the composition adjustment component 116 may simply utilize the cached representations of a rotated image (which obviates the need for rotation calculations), and when each representation of a bitmap image is composited, computations associated with compositing transparent and/or opaque pixels are also avoided.

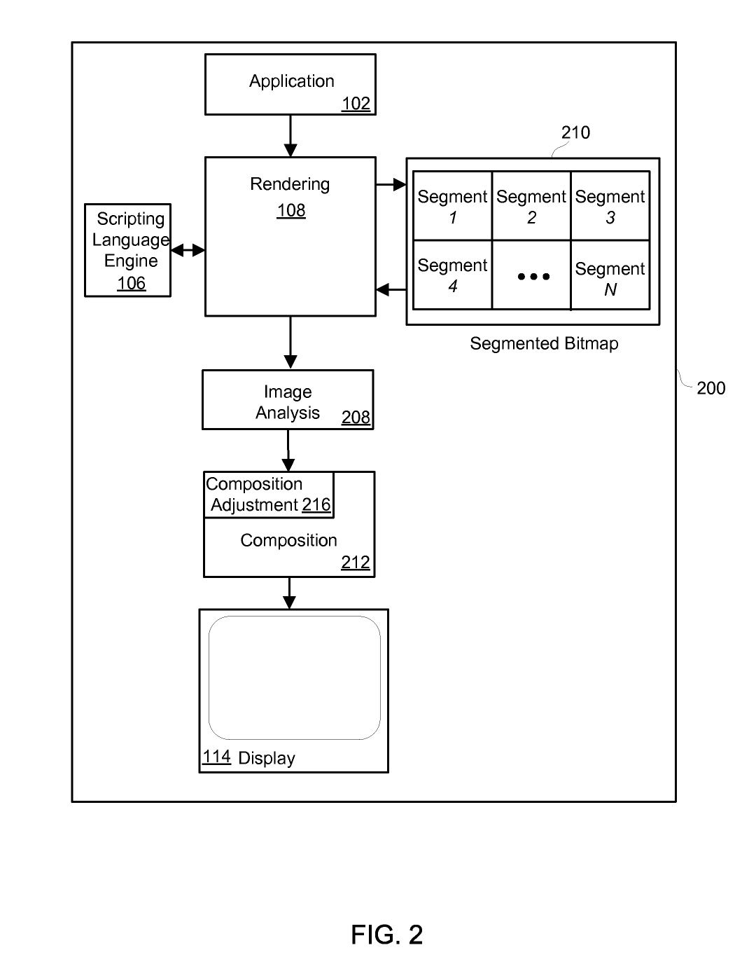

Referring next to FIG. 2 shown is another content display device 200 in which an array of segments of a bitmap image are stored and retrieved from a cache 210. The operation of the content display device 200 in this instance is very similar to the operation of the content display device described with reference to FIG. 1 except that instead of N separate bitmap images being decoded and stored (e.g., that are used to generate animation), a single bitmap image is decoded and placed in the cache 210, and the single bitmap image includes an array of N segments, and each of the N segments are separately retrieved and composited.

As a consequence, the image analysis component 208 in this implementation identifies a pattern of usage of each of the segments, and if the usage pattern indicates that a particular segment is likely to be retrieved and utilized again (e.g., because it has already been utilized more than once), the image analysis component 208 identifies whether at least some compositing computations may be avoided a next time the particular segment is utilized again. The analysis of a segment of the single bitmap image is much the same as the analysis described in connection with FIG. 1 of each of the N bitmap images. For example, large contiguous portions of transparent pixels may be skipped during compositing; large contiguous portions of opaque pixels may be copied; and each representation of a rotated segment may be cached and retrieved from the cache during compositing.

And if at least some of the compositing calculations may be avoided, the composition adjustment component 216 alters operation of the composition component 212 (in the same manner as the composition adjustment component 116 discussed above with reference to FIG. 1) so as to reduce compositing computations that are effectuated by the composition component 212.

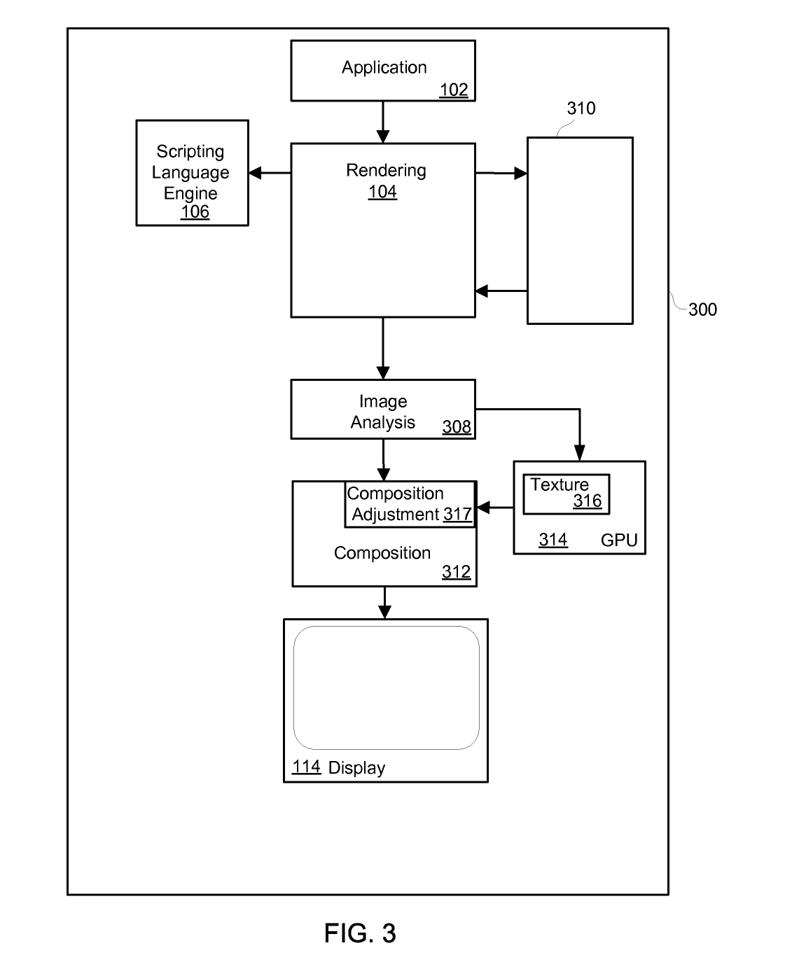

Referring next to FIG. 3, shown is another embodiment of a content display device 300. As shown, in this embodiment the content display device 300 includes a graphics processing unit 314 in communication with the image analysis component 308 and a composition component 312. In this embodiment, the image analysis component 308 operates in a similar manner to the image analysis components 108, 208 described with reference to FIGS. 1 and 2 except that when the image analysis component 308 determines that a bitmap image (e.g., a single bitmap image or a segment of a bit map image) is likely to be used repeatedly, the image analysis 308 component loads the bitmap image as a texture 316 in the graphics processing unit 314, and the graphics processing unit 314 receives and holds, for repeated retrieval of the texture 316 by the composition adjustment component 317.

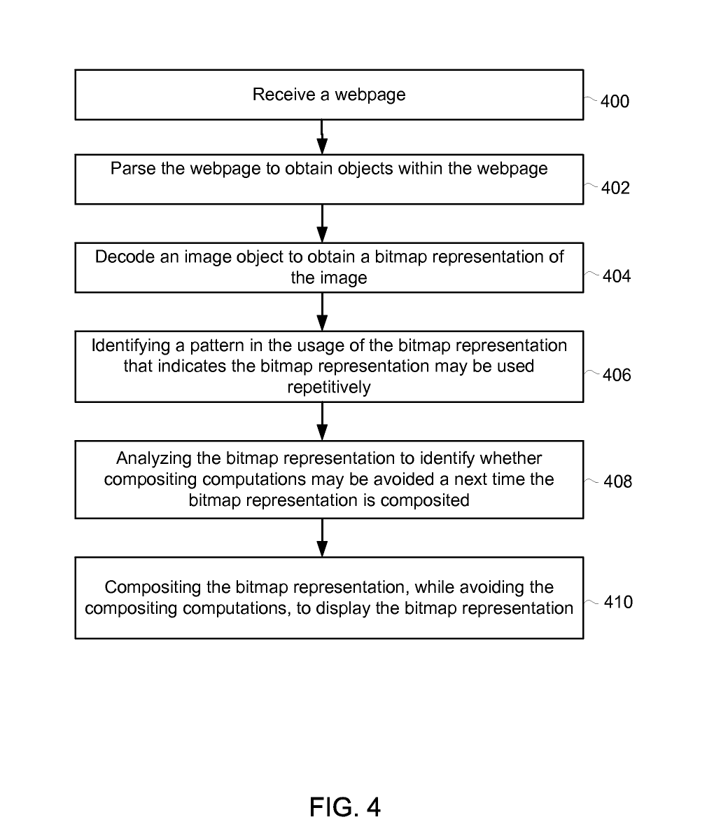

Referring next to FIG. 4, it is a flowchart depicting steps that may be traversed in connection with the embodiments described with reference to FIGS. 1-3. As shown, initially webpage content that includes a plurality of objects is received (Block 400). For example, the webpage content may be received in response to the application 102 requesting a webpage. The webpage is then parsed (e.g., by the rendering component 108) to obtain the objects in the webpage (Block 402), and image objects among the obtained objects are decoded to obtain bitmap representations of the images (Block 404).

As shown, a pattern of usage of one or more of the bitmap representations that indicates the one or more of the bitmap representations may be used repetitively is then identified (e.g., by the image analysis component 108, 208, 308)(Block 406). As discussed above, in some implementations the image analysis component 108, 208, 308 tracks a number of times that a bitmap image is utilized, and if the number of times the bitmap image is utilized exceeds a threshold (e.g., a configurable threshold of two or more instances of use), then the likelihood that the bitmap image will be used again (e.g., in a repetitive manner) is high enough that an analysis of the bitmap image is warranted. As a consequence, if there is a pattern of use that indicates the bitmap image will be used repetitively, the bitmap representation is analyzed to identify whether compositing computations may be avoided a next time the bitmap representation is composited (Block 408).

As discussed, bitmap images may be analyzed to determine if a contiguous portion of pixels include transparent (e.g., alpha channel is 0) and/or opaque (e.g., alpha channel is 255) pixels. In addition, the use of bitmap images may be analyzed to determine if one or more of the bitmap images are being repetitively rotated.

As depicted, the bitmap representations are then composited while avoiding the compositing computations to display the bitmap image (Block 410). For example, transparent pixels are skipped, opaque pixels may be copied, and representations of a bitmap image that is rotated may be cached, and retrieved from the cache, so that rotation calculations need not be performed.

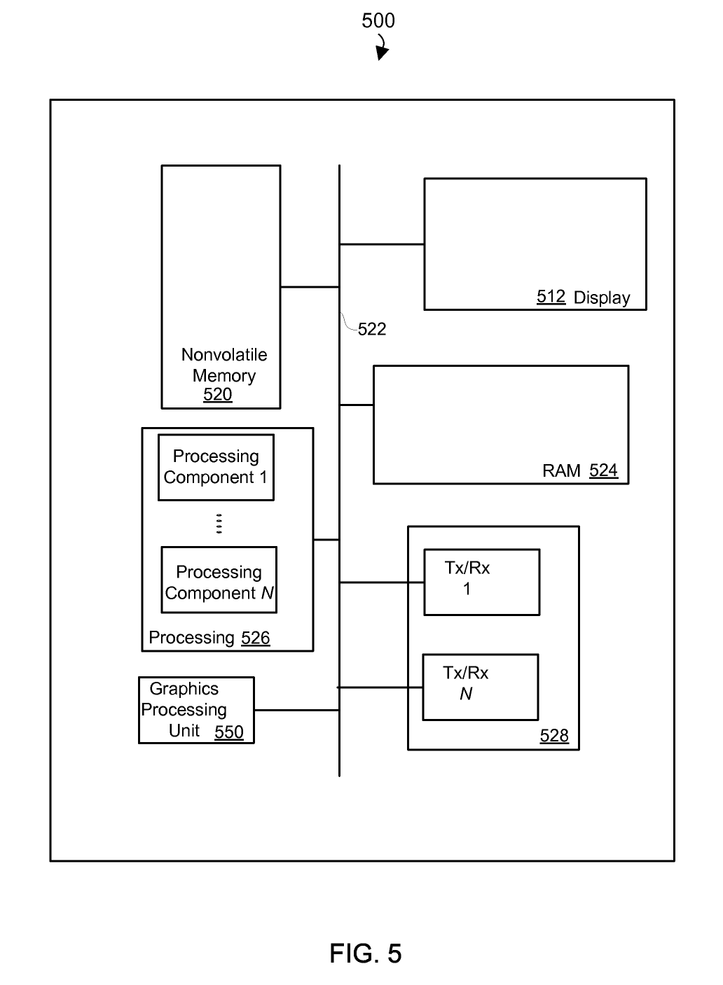

Referring next to FIG. 5, shown is a block diagram depicting physical components of an exemplary content display device 500 that may be utilized to realize the content display devices 100, 200, 300 described with reference to FIGS. 1-3. As shown, the content display device 500 in this embodiment includes a display portion 512, and nonvolatile memory 520 that are coupled to a bus 522 that is also coupled to random access memory (“RAM”) 524, a processing portion (which includes N processing components) 526, a transceiver component 528 that includes N transceivers, and a graphics processing component 550. Although the components depicted in FIG. 5 represent physical components, FIG. 5 is not intended to be a hardware diagram; thus many of the components depicted in FIG. 5 may be realized by common constructs or distributed among additional physical components. Moreover, it is certainly contemplated that other existing and yet-to-be developed physical components and architectures may be utilized to implement the functional components described with reference to FIG. 5.

This display portion 512 generally operates to provide a presentation of content to a user, and in several implementations, the display is realized by an LCD or OLED display. In general, the nonvolatile memory 520 functions to store (e.g., persistently store) data and executable code including code that is associated with the functional components depicted in FIGS. 1-3. In some embodiments for example, the nonvolatile memory 520 includes bootloader code, modem software, operating system code, file system code, and code to facilitate the implementation of one or more portions of the image analysis components 108, 208, 308 and composition adjustment components 116, 216 discussed in connection with FIGS. 1-2 as well as the other web browser components.

In many implementations, the nonvolatile memory 520 is realized by flash memory (e.g., NAND or ONENAND™ memory), but it is certainly contemplated that other memory types may be utilized as well. Although it may be possible to execute the code from the nonvolatile memory 520, the executable code in the nonvolatile memory 520 is typically loaded into RAM 524 and executed by one or more of the N processing components in the processing portion 526.

The N processing components in connection with RAM 524 generally operate to execute the instructions stored in nonvolatile memory 520 to effectuate the functional components depicted in FIGS. 1 and 2. As one of ordinarily skill in the art will appreciate, the processing portion 526 may include a video processor, modem processor, DSP, and other processing components. The graphics processing unit (GPU) 550 depicted in FIG. 5 may be used to realize the graphics processing unit 314 described with reference to FIG. 3.

The depicted transceiver component 528 includes N transceiver chains, which may be used for communicating with external devices via wireless networks. Each of the N transceiver chains may represent a transceiver associated with a particular communication scheme.

In conclusion, embodiments of the present invention improve the display of animated content (e.g., in terms of speed and/or performance) and/or reduce power consumption by reducing compositing calculations that would normally be carried out. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for displaying content on a content display device, the method comprising:
receiving webpage content that includes a plurality of objects;
decoding an image object to obtain a bitmap representation of the image;
identifying a pattern of usage of the bitmap representation that indicates the bitmap representation may be used repetitively when the plurality of objects are composited to create a composite view;
analyzing the bitmap representation to identify whether compositing computations may be avoided a next time the bitmap representation is composited;
compositing the bitmap representation, while avoiding at least some of the compositing computations, to display the bitmap representation; and
displaying the composite view.

2. The method of claim 1, including:
loading the bitmap representation of the image as a texture into a graphics processing unit of the communication device; and
holding the texture in the graphics processing unit for repeated use when compositing.

3. The method of claim 1, wherein the analyzing includes analyzing the bitmap representation to determine whether an alpha channel for bits in the image is set to 0 or 255.

4. The method of claim 1, including:
analyzing the bitmap representation to identify contiguous portions of the bitmap representation that have pixels with an alpha value of zero; and
skipping the compositing of the contiguous portions of the bitmap representation that have pixels with an alpha value of zero.

5. The method of claim 1, including:
analyzing the bitmap representation to identify contiguous portions of the bitmap representation that have pixels with an alpha value of 255; and
copying the contiguous portions of the bitmap representation that have pixels with an alpha value of 255.

6. The method of claim 1, wherein the bitmap representation includes a plurality of image segments, wherein the image segments are sequentially composited.

7. The method of claim 1, wherein the analyzing includes analyzing the bitmap representation to determine whether the bitmap representation is repetitively rotated, and compositing includes retrieving and compositing cached representations of rotational-states of the bitmap image.

8. A content display device including:
a rendering component disposed to receive, parse, and decode webpage image content to obtain a plurality of bitmap images;
a cache to store the plurality of bitmap images;
an image analysis component configured to identify a pattern of usage of each of the plurality of bitmap images that indicates whether each of the plurality of bitmap images may be used repetitively, and to identify whether at least some compositing computations may be avoided a next time the repeated bitmap images are composited;
a composition component to composite one or more of the plurality of bitmap images to generate a composite view;
a composition adjustment component configured to alter, responsive to the identified patterns of usage of each of the plurality of bitmap images, operation of the composition component so as to reduce compositing computations that are effectuated by the composition component; and
a display that displays the composite view.

9. The content display device of claim 8, including a graphics processing unit configured to receive and hold, for repeated use, one or more of the plurality of bitmap images as textures when the one or more of the plurality of bitmap images are used repetitively.

10. The content display device of claim 8, wherein the image analysis component analyzes whether each of the plurality of bitmap images that may be used repeatedly include bits that with an alpha channel that is 0 or 255.

11. The content display device of claim 8, wherein the image analysis component analyzes whether each of the plurality of bitmap images that may be used repeatedly include contiguous portions that have pixels with an alpha value of zero, and the composition adjustment component is configured to alter the operation of the composition component so that the contiguous portions of pixels that have an alpha value of zero are skipped during compositing.

12. The content display device of claim 8, wherein the plurality of bitmap images are segments within a larger bitmap image.

13. The content display device of claim 8 wherein the image analysis component identifies whether each of the plurality of bitmap images is rotated repetitively, and if a particular bitmap image is rotated repetitively, representations of the bitmap image corresponding to rotated versions of the bitmap image are cached to enable the representations of the bitmap image to be retrieved during compositing, thereby avoiding rotation-related computations.

14. The content display device of claim 8 including a scripting language engine that executes scripting language code and directs, when executing the scripting language code, the retrieval and display of the bitmap images that are stored in the cache.

15. A content display device including:
means for receiving webpage content that includes a plurality of objects;
means for decoding an image object to obtain a bitmap representation of the image;
means for identifying a pattern of usage of the bitmap representation that indicates the bitmap representation may be used repetitively when the plurality of objects are composited to create a composite view;
means for analyzing the bitmap representation to identify whether compositing computations may be avoided a next time the bitmap representation is composited;
means for compositing the bitmap representation, while avoiding at least some of the compositing computations, to display the bitmap representation; and
means for displaying the composite view.

16. The content display device of claim 15, including:
means for loading the bitmap representation of the image as a texture into a graphics processing unit of the communication device; and
means for holding the texture in the graphics processing unit for repeated use when compositing.

17. The content display device of claim 15, wherein the means for analyzing includes means for analyzing the bitmap representation to determine whether an alpha channel for bits in the image is set to 0 or 255.

18. The content display device of claim 15, including:
means for analyzing the bitmap representation to identify contiguous portions of the bitmap representation that have pixels with an alpha value of zero; and
means for skipping the compositing of the contiguous portions of the bitmap representation that have pixels with an alpha value of zero.

19. The content display device of claim 15, including:
means for analyzing the bitmap representation to identify contiguous portions of the bitmap representation that have pixels with an alpha value of 255; and
means for copying the contiguous portions of the bitmap representation that have pixels with an alpha value of 255.

20. The content display device of claim 15, wherein the bitmap representation includes a plurality of image segments, wherein the image segments are sequentially composited.

21. The content display device of claim 15, wherein the means for analyzing includes means for analyzing the bitmap representation to determine whether the bitmap representation is repetitively rotated, and the means for compositing includes means for retrieving and means for compositing cached representations of rotational-states of the bitmap image.

22. A non-transitory, tangible computer readable storage medium, encoded with processor readable instructions to perform a method for communicating between communication devices, the method comprising:
receiving webpage content that includes a plurality of objects;
decoding an image object to obtain a bitmap representation of the image;
identifying a pattern of usage of the bitmap representation that indicates the bitmap representation may be used repetitively when the plurality of objects are composited to create a composite view;
analyzing the bitmap representation to identify whether compositing computations may be avoided a next time the bitmap representation is composited;
compositing the bitmap representation, while avoiding at least some of the compositing computations, to display the bitmap representation; and
displaying the composite view.

23. The non-transitory, tangible computer readable storage medium of claim 22, the method including:
loading the bitmap representation of the image as a texture into a graphics processing unit of the communication device; and
holding the texture in the graphics processing unit for repeated use when compositing.

24. The non-transitory, tangible computer readable storage medium of claim 22, wherein analyzing includes analyzing the bitmap representation to determine whether an alpha channel for bits in the image is set to 0 or 255.

25. The non-transitory, tangible computer readable storage medium of claim 22, the method including:
analyzing the bitmap representation to identify contiguous portions of the bitmap representation that have pixels with an alpha value of zero; and
skipping the compositing of the contiguous portions of the bitmap representation that have pixels with an alpha value of zero.

26. The non-transitory, tangible computer readable storage medium of claim 22, the method including:
analyzing the bitmap representation to identify contiguous portions of the bitmap representation that have pixels with an alpha value of 255; and
copying the contiguous portions of the bitmap representation that have pixels with an alpha value of 255.

27. The non-transitory, tangible computer readable storage medium of claim 22, wherein the bitmap representation includes a plurality of image segments, wherein the image segments are sequentially composited.

28. The non-transitory, tangible computer readable storage medium of claim 22, wherein the analyzing includes analyzing the bitmap representation to determine whether the bitmap representation is repetitively rotated, and compositing includes retrieving and compositing cached representations of rotational-states of the bitmap image.
